(19) United States
(12) Patent Application Publication
(10) Pub. No.: US 2026/0084808 A1
(43) Pub. Date: Mar. 26, 2026

(54) Tiltrotor Aircraft Control System

(71) Applicant: Textron eAviation Inc., Providence, RI (US)

(72) Inventors: Steven G. Hagerott, Wichita, KS (US); William Valentine, Bel Aire, KS (US); Nathaniel Van Evera, Derby, KS (US); Alec Mitchell, Wichita, KS (US); Steven Ringer, Goddard, KS (US)

(73) Assignee: Textron eAviation Inc., Providence, RI (US)

(21) Appl. No.: 18/898,258

(22) Filed: Sep. 26, 2024

(51) Int. Cl. B64C 13/50; B64C 13/04; B64C 29/00

(52) U.S. Cl. CPC B64C 13/503; B64C 13/0421; B64C 29/0033

(57) ABSTRACT

A flight control system for a tiltrotor aircraft includes a plurality of propulsion systems each independently tiltable between a vertical position and a horizontal position by aircraft effectors. A flight control computer controls the tiltrotor aircraft effectors in response to inputs from inceptors. The flight control computer comprises one or more processors and a memory storing instructions for controlling aircraft effectors. The instructions cause the flight control computer to receive inputs from a first inceptor and a second inceptor, and apply flight control laws to map the inputs to command longitudinal and vertical movement of the tiltrotor aircraft. The first inceptor inputs command longitudinal speed and acceleration in both hover and cruise flight modes, while the second inceptor inputs command climb and descent rates in both hover and cruise flight modes.

### BACKGROUND

Aircraft utilizing electric power to drive rotors, props, or fans enable electric vertical takeoff and landing (eVTOL) operation. These aircraft are particularly suitable for urban air mobility due to their ability to operate without the need for runways. Some aircraft may also include propulsion systems that combine engine-generated electricity with battery-stored power or provide all required power through an engine-driven generator. As used herein, the term eVTOL also includes VTOLs that use hybrid electric (with an engine running a generator producing electricity and battery stored power) or turbo electric (an engine running a generator providing all power required) propulsion systems.

Traditional aircraft control systems rely on moveable aerodynamic surfaces on the wings and tail to manage altitude and attitude, including roll, pitch, and yaw. Some aircraft may employ power-assisted or fully powered control systems to transmit operator inputs to these surfaces. While many powered control systems use mechanical linkages to command surface actuators, systems that replace mechanical linkages with computerized command and feedback loops are increasingly common, enhancing control precision and reliability.

### SUMMARY

Embodiments are directed to systems and methods for controlling an aircraft using a flight control system. A flight control computer is configured to control aircraft effectors in response to inputs from inceptors. The flight control computer stores instructions for controlling aircraft effectors.

According to one aspect of the present invention, a flight control system for a tiltrotor aircraft comprises a plurality of propulsion systems each independently tiltable between a vertical position and a horizontal position by aircraft effectors; and a flight control computer configured to control the tiltrotor aircraft effectors in response to inputs from inceptors, the flight control computer comprising one or more processors and a memory, wherein the memory stores instructions for controlling aircraft effectors, the instructions causing the flight control computer to perform the steps of receiving inputs from a first inceptor and a second inceptor; and applying flight control laws to map the inputs to command longitudinal and vertical movement of the tiltrotor aircraft, wherein the first inceptor inputs command longitudinal speed and acceleration of the tiltrotor aircraft in both a hover flight mode and a cruise flight mode, and the second inceptor inputs command climb and descent rates in both hover and cruise flight modes.

According to another aspect, the instructions further cause the flight control computer to perform the steps of converting a signal representing a longitudinal force applied to the first inceptor into an altitude rate change in hover flight mode or into a flight path angle change in cruise flight mode; converting a signal representing a longitudinal force applied to the second inceptor into a longitudinal velocity in hover flight mode or into a longitudinal acceleration in cruise flight mode; converting a signal representing a lateral force applied to the second inceptor into a lateral velocity in hover flight mode or into a roll rate in cruise flight mode; and converting a signal representing a twist force applied to the second inceptor into a yaw rate command in hover flight mode or into a sideslip command in cruise flight mode.

According to yet another aspect, the instructions further cause the flight control computer to perform the steps of converting a signal representing a longitudinal force applied to the first inceptor into a thrust offset command, wherein forward-directed forces correspond to a thrust decrease and backward-directed forces correspond to a thrust increase; converting signals from a switch on the first inceptor into a thrust bias setting; converting a signal representing a longitudinal force applied to the second inceptor into a pitch attitude command; converting a signal representing a lateral force applied to the second inceptor into a roll attitude command; converting a signal representing a twist force applied to the second inceptor into a yaw rate command; and converting signals from a switch on the second inceptor into a conversion command.

According to another aspect, the instructions further cause the flight control computer to perform the steps of converting a signal representing a longitudinal force applied to the first inceptor into an altitude rate change in hover flight mode or into a flight path angle change in cruise flight mode; converting a signal representing a longitudinal force applied to the second inceptor into a longitudinal velocity in hover flight mode or into a longitudinal acceleration in cruise flight mode; converting a signal representing a lateral force applied to the second inceptor into a lateral velocity in hover flight mode or into a roll rate in cruise flight mode; and converting signals representing forces applied to floor pedals into a yaw rate command in hover flight mode or into a sideslip command in cruise flight mode.

According to another aspect, the instructions further cause the flight control computer to transition from longitudinal velocity and lateral velocity changes in hover flight mode to longitudinal acceleration changes and roll rate changes in cruise flight mode.

According to another aspect, the instructions further cause the flight control computer to transition from longitudinal velocity and lateral velocity changes in hover flight mode to longitudinal acceleration changes and roll rate changes in cruise flight mode at a defined speed or the transition may be blended between modes

According to yet another aspect, the instructions further cause the flight control computer to transition from altitude rate changes and yaw rate changes in hover flight mode to flight path angle changes and sideslip changes in cruise flight mode at a first airspeed when the tiltrotor aircraft is accelerating, and transition from flight path angle changes and sideslip changes in cruise flight mode to altitude rate changes and yaw rate changes in hover flight mode at a second airspeed when the tiltrotor aircraft is decelerating, wherein the second airspeed is lower than the first airspeed.

According to another aspect, the plurality of propulsion systems have a generally vertical orientation in the hover mode and a generally horizontal orientation in the cruise mode, and additional propulsion systems are fixed in a horizontal position.

### BRIEF DESCRIPTION OF THE DRAWINGS

Having thus described the invention in general terms, reference will now be made to the accompanying drawings, which are not necessarily drawn to scale, and wherein:

FIGS. 1A and 1B illustrate an example tiltrotor aircraft that is convertible between a VTOL or hover mode and a cruise mode.

FIGS. 2A and 2B illustrate an example tiltrotor aircraft embodiment that includes ducted rotors or fans.

FIG. 3 is a block diagram showing an exemplary FBW system for an aircraft such as those illustrated in FIGS. 1A, 1B, 2A, and 2B.

FIG. 4 illustrates an example embodiment of a flight control configuration for an aircraft such as those illustrated in FIGS. 1A, 1B, 2A, and 2B.

FIG. 5 is a perspective view of an illustrative example of an inceptor that may be used with embodiments disclosed herein.

FIG. 6 illustrates an inceptor mapping for a constant axis mode of aircraft operation.

FIG. 7 illustrates an inceptor mapping for a baseline vector rate mode.

FIG. 8 illustrates an inceptor mapping for a reversionary baseline attitude direct mode.

FIG. 9 illustrates an inceptor mapping for a baseline vector rate mode with pedals.

FIG. 10 illustrates an inceptor mapping for a forward priority vector rate mode.

FIG. 11 illustrates an inceptor mapping for a forward priority vector rate mode with pedals.

FIG. 12 illustrates an inceptor mapping for a reversionary forward priority attitude direct mode.

While the system of the present application is susceptible to various modifications and alternative forms, specific embodiments thereof have been shown by way of example in the drawings and are herein described in detail. It should be understood, however, that the description herein of specific embodiments is not intended to limit the system to the particular forms disclosed, but on the contrary, the intention is to cover all modifications, equivalents, and alternatives falling within the spirit and scope of the present application as defined by the appended claims.

### DETAILED DESCRIPTION

Illustrative embodiments of the system of the present application are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above,” “below,” “upper,” “lower,” “top,” “bottom,” or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y.

Additionally, as referred to herein in this Specification, the terms “forward,” “aft,” “inboard,” and “outboard” may be used to describe relative relationship(s) between components and/or spatial orientation of aspect(s) of a component or components. The term “forward” may refer to a spatial direction that is closer to a front of an aircraft relative to another component or component aspect(s). The term “aft” may refer to a spatial direction that is closer to a rear of an aircraft relative to another component or component aspect(s). The term “inboard” may refer to a location of a component that is within the fuselage of an aircraft and/or a spatial direction that is closer to or along a centerline of the aircraft (wherein the centerline runs between the front and the rear of the aircraft) or other point of reference relative to another component or component aspect. The term “outboard” may refer to a location of a component that is outside the fuselage of an aircraft and/or a spatial direction that farther from the centerline of the aircraft or other point of reference relative to another component or component aspect.

Further, the present disclosure may repeat reference numerals and/or letters in the various examples. This repetition is for the purpose of simplicity and clarity and does not in itself dictate a relationship between the various embodiments and/or configurations discussed. Example embodiments that may be used to implement the features and functionality of this disclosure will now be described with more particular reference to the accompanying Figures.

Described herein are various configurations of example hexrotor aircraft; however, it will be understood that other aircraft configurations may use embodiments of the flight control systems disclosed herein.

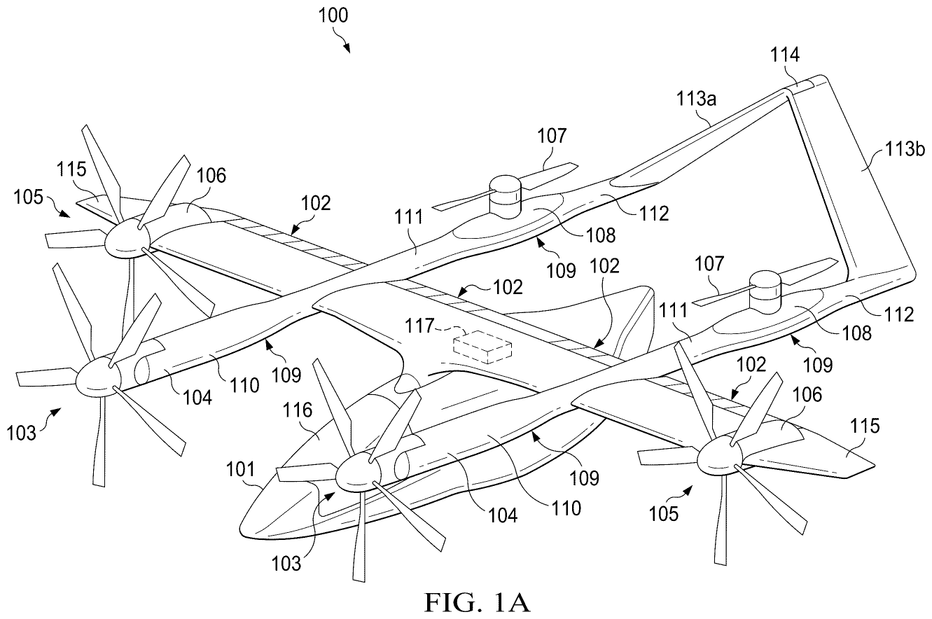

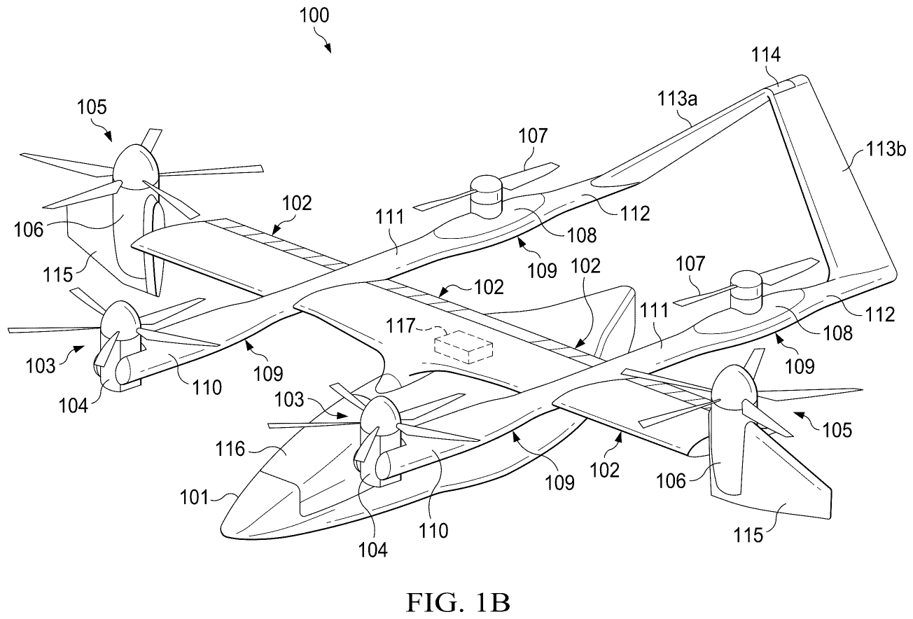

FIGS. 1A and 1B illustrate an example tiltrotor aircraft 100 that is convertible between a cruise mode (also commonly referred to as airplane mode or wing-borne flight), shown in FIG. 1A, that allows for forward flight as well as horizontal takeoff and landing and a VTOL or hover mode (also commonly referred to as helicopter mode), shown in FIG. 1B, that allows for vertical takeoff and landing, hovering, and low speed directional movement. Because the aircraft 100 includes six rotor assemblies, the aircraft may be referred to as a “hexrotor aircraft.”

Aircraft 100 includes a center fuselage 101 mounted underneath a laterally extending wing 102. An inner pair of propulsion systems having rotors or propellers 103 are each operated by electric motors or engines 104. An outer pair of propulsion systems having rotors 105 are each operated by electric motors or engines 106. Motors/engines 104 are supported on the front end of laterally-spaced substantially-parallel booms 109. The terms “boom” or “booms” as used in this application should be interpreted as merely meaning some laterally existing structure on the aircraft 100 and not be limited to any particular configuration. For example, the booms should not be considered to be longitudinally extending or have any other particular configuration unless specifically referenced as being so. In the FIG. 1A embodiment, each of booms 109 has a forward portion 110, an intermediate portion 111, and a rearward portion 112.

Supported between the intermediate 111 and rearward portions 112 on each boom 109 are a pair of lift rotors 107 each operated by a dedicated electric motor or engine 108. It will be recognized that while lift rotors 107 are illustrated as being disposed above (i.e., on the top side of) booms 109, the lift rotors 107 may alternatively be disposed under (i.e., on underside of) booms 109 in other embodiments.

Angled stabilizers 113a and 113b are mounted on the rearward portions 112 of each boom 109. The stabilizers 113a and 113b are configured to extend upwardly and inwardly from rearward portions 112. The stabilizers 113a and 113b converge at an apex 114 where the upper end of each stabilizer is connected to the other. The term “stabilizer” as used herein should be interpreted as any structure that has an aerodynamically stabilizing influence in longitudinal or directional flight dimensions (e.g., pitch, yaw). The term “stabilizer” should also be construed as allowing for fixed, adjustable, or even movable structures. Thus, this term should not be considered to specify any particular tail configuration and could be referenced to describe angled (e.g., a V-tail configuration), horizontal, vertical, or even non-planar stabilizing arrangements that contribute to longitudinal or directional control.

In the illustrated embodiment, the propulsion systems 105/106 are tiltably connected to the wing 102 proximate outboard ends thereof, and propulsion systems 103/104 are tiltably connected to the forward end 110 of wing booms 109. The electric motors or engines 104 and 106 rotate or tilt to move between a hover mode (FIG. 1B) and a cruise flight mode (FIG. 1A), which may also be referred to as a forward flight mode or fixed wing mode. When the propulsion system pylons (i.e., electric motors or engines 104, 106) are positioned between the hover position (e.g., at 90° or vertical) and the cruise position (e.g., at 0° or horizontal), this is commonly referred to as a conversion mode or conversion corridor. Rotation of rotors 103, 105, and 107 generate lift while aircraft 100 is operating in helicopter mode. As electric motors or engines 104 and 106 are rotated toward a horizontal position, rotors 103 and 105 transition to generating more thrust than lift as aircraft 100 transitions to operating in a forward-facing cruise mode in which wing 102 generates lift.

Tiltable rotors 103 and 105 are shown as having five rotor blades and lift rotors 107 are shown as having two rotor blades in FIGS. 1A/B. It should be recognized that other numbers of rotor blades may be implemented for the various rotor systems 103, 105, 107 without departing from the spirit and the scope of the embodiments described. It should also be recognized that the rotor assemblies of rotors 103 may include a different number of rotor blades than the rotor assemblies of rotors 105.

In accordance with features of embodiments described herein, electric motors or engines 106 are disposed on the outboard ends of wing 102 and are connected to the inboard ends of wing tips 115. The wing tips 115 move with electric motors or engines 106 and tilt relative to wing 102 between a first position (shown in FIG. 1A) in which propulsion systems 105/106 and wing tips 115 are configured in a cruise mode, and a second position (shown in FIG. 1B) in which propulsion systems 105/106 and wing tips 115 are configured in a hover mode. The primary benefit of wing tips 115, which extension outboard of electric motors or engines 106, is greater efficiency in the cruise mode by adding additional wingspan. The wing tip extensions 115 rotate with electric motors or engines 106 to minimize download in hover mode, which would be due to the impingement of rotor downwash on the top surfaces of wing tips 115.

Similarly, forward propulsion systems 103/104 are tiltably connected to forward ends 110 of booms 109 and are tiltable between a first position (shown in FIG. 1A) in which rotors 103 are configured in a cruise mode, and a second position (shown in FIG. 1B) in which rotors 103 are configured in a hover mode. In accordance with features of embodiments described herein, aft propulsion systems 107/108 are fixedly attached to booms 109 at a position located aft of the wing 102. Aft rotors 107 do not convert between hover mode and cruise mode.

The position of rotors 103 and 105, as well as the pitch of individual rotor blades, can be selectively controlled in order to control direction, thrust, and lift of aircraft 100. As previously noted, electric motors or engines 104 and 106 are each convertible, relative to fuselage 101, between a horizontal position (FIG. 1A) and a vertical position (FIG. 1B). Electric motors or engines 104 and 106 are in the vertical position during vertical takeoff and landing mode. Vertical takeoff and landing mode may be considered to include hover operations of aircraft 100. Electric motors or engines 104 and 106 are in the horizontal position during forward flight mode, in which aircraft 100 is in forward flight. In forward flight mode, rotors 103, 105 direct their respective thrusts in the aft direction to propel aircraft 100 forward. Aircraft 100 is operable to fly in all directions during the vertical takeoff and landing mode configuration of FIG. 1B, although faster forward flight is achievable while in the forward flight mode configuration of FIG. 1A. The electric motors or engines 104 and 106 may be tiltable between the vertical and horizontal positions by actuators (not shown) that are tiltable in response to commands originating from a pilot and/or a flight control system. It should be noted that, although electric motors or engines 104 and 106 are shown and described as being tiltable between cruise and hover positions, those propulsion systems may be fixed in the hover positions similarly to rotor 107.

In certain embodiments, when aircraft 100 is in cruise mode, the rotors 103 and/or 105 may cease rotation. In embodiments in which rotors 107 are also fixed (i.e., do not convert between hover and cruise modes), the rotors 107 may also cease rotation when aircraft 100 is in cruise mode. For example, rotors 107 may stop rotation so that the rotor blades in the respective rotor assemblies are aligned with booms 109 in order to reduce the surface area exposed to the airstream thereby minimizing drag in the cruise mode. Having fewer active rotor assemblies during cruise mode may improve blade loading and propulsive efficiency of the rotors. In addition, stopping the aft rotors 107 during cruise mode avoids ingestion of the wakes from the forward rotors 103, which would make the aft rotors 107 less efficient. Further efficiencies may be achieved during cruise flight by stopping either forward facing rotors 103 or 105 and feathering their respective rotor blades so that only one set of electric motors or engines 104 or 106 (i.e., only the inboard or only the outboard propulsion system) is online.

With six rotor assemblies, an individual rotor system may be lost while still allowing aircraft 100 to hover even without motor redundancy per rotor. In the event of a propeller or rotor blade failure, the rotor on the opposite side of the aircraft would be powered down, allowing aircraft 100 to hover as a quad copter with the four remaining rotor systems operating at elevated power levels. In accordance with features of embodiments described herein, if the aft left rotor were to fail, the forward right rotor would also be powered down, allowing the thrust on the remaining rotors to balance. Electric power to the motors 104, 106, 108 allows the distributed nature of the aircraft 100 to stay weight efficient without requiring extensive cross-connects.

In accordance with embodiments described herein, a drive system may be coupled to each electric motors or engines 104 or 106. The drive system may include one or more fixed electric motors coupled to an off-axis tilting gearbox. The tilting configuration may have a motor attached to a drive system for reduction of RPM or the motor itself may be direct drive directly turning the respective rotors at the desired speed. Tilting of the rotor 103 and 105 assemblies can take place with respect to the stationary motors, wing, or other stationary structure of aircraft 100. The electric motors or engines 104 or 106 may tilt with the rotors 103 and 105, respectively, or the electric motors or engines 104 or 106 may remain stationary while the rotors 103 and 105 rotate. Tilting may occur with a portion of an attached wing or boom, or the wing or boom may stay fixed with only the rotor or duct pylon tilting.

One or more control surfaces or effectors (not shown) may be included on the fuselage 101, wing 102, or angled stabilizers 113a and 113b, such as one or more aileron, elevator, horizontal stabilizer, vertical stabilizer, flap, slat, spoiler, or rudder. Such control surfaces are used to control or stabilize flight of the aircraft 100 in certain flight modes. For example, flight control devices, such as ailerons, elevators, and rudders, may be used for aircraft control during cruise mode flight.

In some configurations, center fuselage 101 has a cockpit 116 that includes displays, controls, and instruments. In some embodiments, cockpit 116 is configured to accommodate one or more pilots and/or passengers. It is contemplated, however, that aircraft 100 may be operated remotely, in which case cockpit 116 could be configured as a fully functioning cockpit to accommodate a pilot (and possibly a co-pilot as well) to provide for greater flexibility of use or could be configured with a cockpit having limited functionality (e.g., a cockpit with accommodations for only one person who would function as the pilot operating perhaps with a remote co-pilot or who would function as a co-pilot or back-up pilot with the primary piloting functions being performed remotely). In yet other contemplated embodiments, aircraft 100 could be configured as an unmanned vehicle, in which case cockpit 109 could be eliminated entirely in order to save space and cost.

In some embodiments, a fly-by-wire (FBW) system 117 in aircraft 100 sends electrical signals to the propulsion systems 130/14, 105/106, and 107/108 and other control surfaces or effectors in response to a pilot's inputs to flight controls in cockpit 116 or from a remote controller. For example, the tilting of electric motors or engines 104 and 106 and speed of rotors 103, 105, and 107, the pitch of rotor blades, and/or the movement of other effectors may be controlled by inputs from the FBW system 117. FBW systems are more complex than simple mechanical/analog systems and provide greater flexibility in aircraft control. In an FBW system, a flight computer, which may be multiply redundant, receives control inputs from the pilot (or from a remote controller) and translates those inputs electronically via electronic actuators into motion of the aircraft control surfaces and effectors. A flight computer may not only translate these motions but may also make real-time corrections to control surfaces to maintain stable flight that would not be feasible without high-speed corrections by the flight computer.

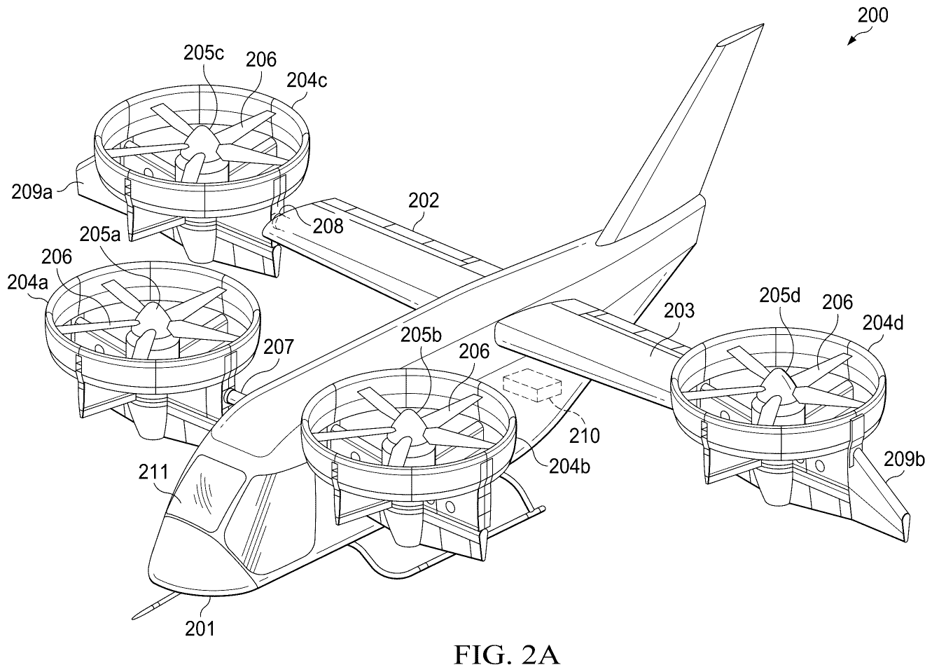

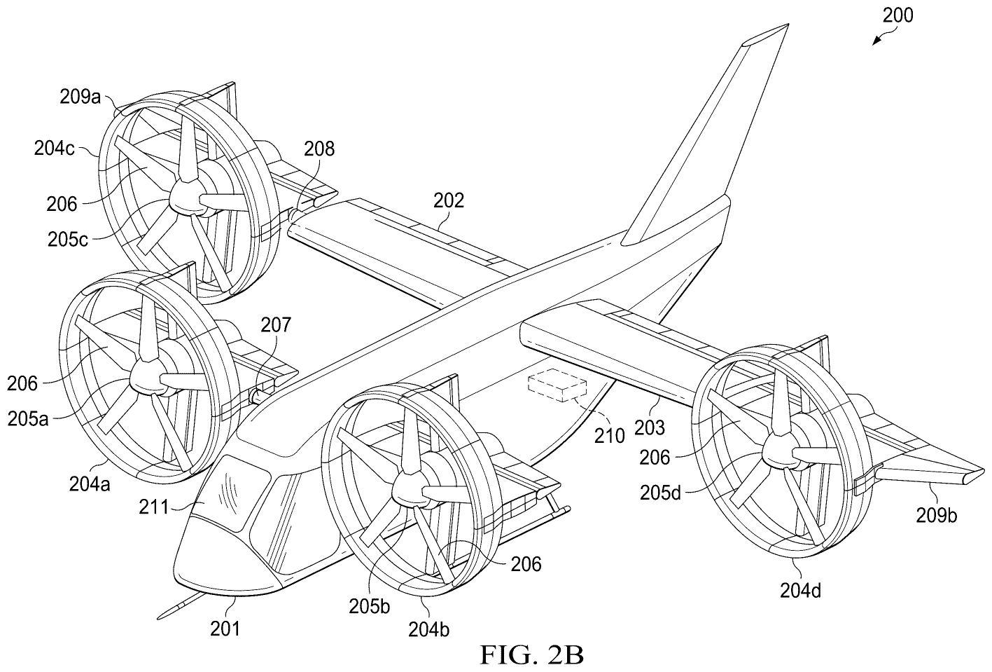

FIGS. 2A and 2B illustrate an example tiltrotor aircraft 200 that includes ducted rotors (or fans). Tiltrotor aircraft 200 is convertible between a helicopter mode (shown in FIG. 2A), which allows for vertical takeoff and landing, hovering, and low speed directional movement, and an airplane mode (shown in FIG. 2B), which allows for forward flight as well as horizontal takeoff and landing.

Aircraft 200 comprises a fuselage 201 with fixed wings 202, 203 that extend from the fuselage 201 and a plurality of rotatable ducts 204a-d that are coupled to the fuselage 201 or the wings 202, 203. Each duct 204a-d houses a power plant for driving rotation of an attached rotor 205a-d. Each rotor 205a-d has a plurality of rotor blades 206 configured to rotate within ducts 204.

In the illustrated embodiment, aircraft 200 is configured with four ducts 204a-d, including two ducts 204a and 204b that form a forward pair of ducts and two ducts 204c and 204d that form an aft pair of ducts. Each duct 204a-d is rotatably coupled to fuselage 201 of aircraft 200 via a spindle. Ducts 204a and 204b are coupled directly to fuselage 201 by a respective spindle 207. Ducts 204c and 204d are each independently coupled to a corresponding end of wing 203 via a respective spindle 208. As shown, each of ducts 204c and 204d includes a winglet 209a, 209b that is coupled thereto. It should be appreciated that aircraft 200 is not limited to the illustrated configuration having four ducts 204, and that aircraft 200 may alternatively be implemented with more or fewer ducts 204. For example, an additional pair of ducts (not shown) may be coupled to the aft section of fuselage 201 behind wings 202, 203.

The position of ducts 204a-d, and optionally the pitch of blades 206, can be selectively controlled to control direction, thrust, and lift of rotors 205a-d. For example, ducts 204a-d are repositionable to convert aircraft 200 between a helicopter mode and an airplane mode. As shown in FIG. 2A, ducts 204a-d are positioned such that aircraft 200 is in helicopter mode, which allows for vertical takeoff and landing, hovering, and low-speed directional movement. As shown in FIG. 2B, ducts 204a-d are positioned such that aircraft 200 is in airplane mode, which allows for high-speed forward-flight. In airplane mode, ducts 204a-d direct their respective thrusts in the aft direction to propel aircraft 200. Aircraft 200 is operable to fly in all directions during the vertical takeoff and landing (i.e., helicopter) mode configuration of FIG. 2A, although faster forward flight is achievable while in the forward flight (i.e., airplane) mode configuration of FIG. 2B. Ducted fans 204a-d may be tiltable between the vertical and horizontal positions by spindles 207, 208, which are rotatable in response to commands originating from a pilot and/or a flight control system of the aircraft 200.

Like rotorcraft 100, tiltrotor aircraft 200 may have an FBW system 210 that sends electrical signals to control aircraft actuators and effectors, such as actuators that control the position of rotatable ducts 204a-d and/or the pitch of rotor blades 206. Also, like aircraft 101, tiltrotor aircraft 200 may be configured for manned or unmanned flight, such as where cockpit 211 may be configured to accommodate a pilot or to be operated remotely.

It should be appreciated that aircraft 100 and 200 are merely illustrative of a variety of aircraft that can implement the embodiments disclosed herein. Other aircraft implementations may include, for example, hybrid aircraft, fixed wing aircraft, unmanned aircraft, gyrocopters, drone aircraft, and other tiltrotor and helicopter configurations, to name a few examples.

FBW systems are provided in aircraft, such as FBW 110 and 210 in aircraft 100 and 200, to assist pilots in stably flying the aircraft and to reduce workload on the pilots. Typical FBW systems provide different control characteristics or responses for stick, throttle, cyclic, collective, or pedal control input in the different flight regimes and may provide stability assistance or enhancement by decoupling physical flight characteristics so that a pilot is relieved from needing to compensate for some flight commands issued to the aircraft. FBW systems may be implemented in one or more flight control computers (FCCs) disposed between inceptors (e.g., pilot controls) and effectors (e.g., flight control surfaces and propulsion systems). The FBW systems provide responses to flight control inputs that assist in operating the aircraft more efficiently or that put the aircraft into a stable flight mode, while still allowing the pilot to override the FBW control inputs. The FBW systems in an aircraft may, for example, automatically adjust power output by the engine to match a control input, adjust rotor pitch in response to a control input, provide automation of one or more flight control procedures, provide for default or suggested control positioning, or the like.

In some embodiments, the FBW system includes an autopilot function that provides automatic flight control for the aircraft. The autopilot may be capable of controlling some or all aircraft flight parameters, such as maintaining speed, heading, or altitude, or managing operations, such as hovering and navigating. The autopilot can relieve a pilot of time-intensive tasks and reduce the pilot's workload.

In some embodiments, the autopilot system provides flight commands to a flight control computer. The flight control computer interprets the flight commands and controls effectors and actuators for control surfaces such as ailerons, flaps, elevators, and rudder. In response to the autopilot's commands, the flight control computer may also signal actuators that control an angular position of the proprotors for a tiltrotor aircraft as well as the pitch or angle of attack for rotor blades. In various embodiments, the effectors may be electric motors and may in various embodiments may be, for example, swashplate actuators, nacelle-position actuators, throttle actuators, landing-gear actuators, or any other type of actuator for controlling a flight parameter. The effectors may also include, for example, rotors, rotor cyclic controls, rotor/propeller collective control, electric motor speed, torque, or current command, propellers, ailerons, rudders, elevators, etc.

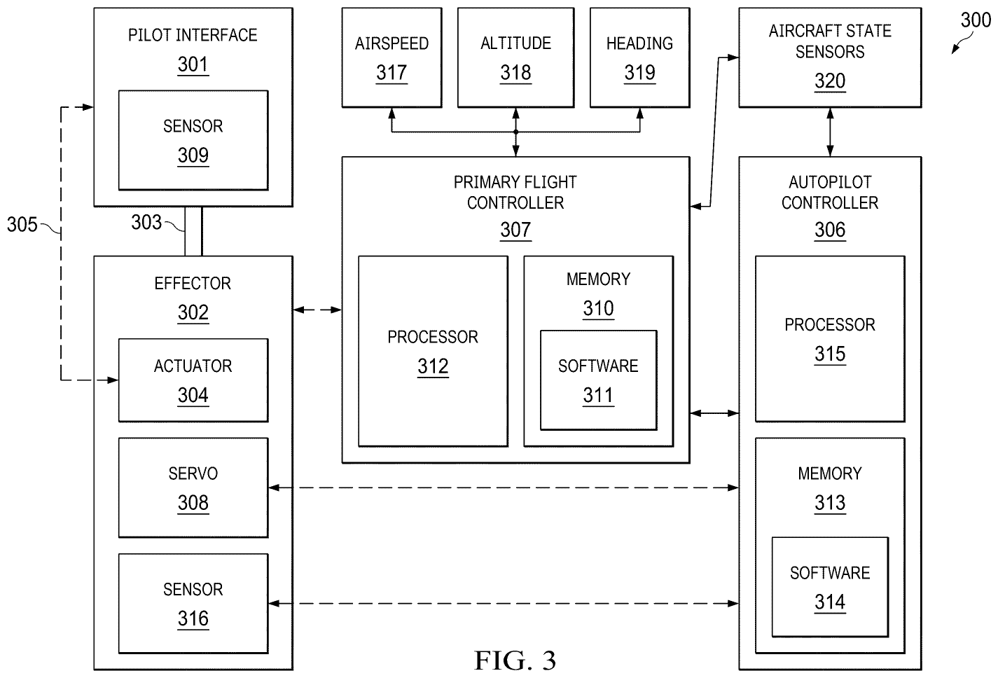

FIG. 3 is a block diagram showing an exemplary FBW system 300 for an aircraft. FBW system 300 may incorporate various control laws for responding to pilot inputs. System 300 may be implemented on any aircraft having an effector that is controllable via a pilot interface and/or an autopilot controller for providing automatic control of the effector. A pilot interface 301 receives control inputs, such as from one or more inceptor in a cockpit, for transmitting control inputs to an effector 302, such as a control surface, rotor blade, ducted rotor, etc. The control inputs may be transmitted directly to effector 302 via a mechanical linkage 303, or control signals may be transmitted to an actuator 304 of effector 302 via a signaling path 305 (e.g., in a fly-by-wire arrangement), or some combination of these may be employed. Actuator 304 may be, for example, a hydraulically powered or electrically powered actuator that responds to electrical control signals from pilot interface 301 or from an FCC, such as autopilot controller 306, flight controller 307, flight director, waypoint navigator, navigation computer, or other navigation solution.

Autopilot controller 306 may receive input commands from a flight controller 307 and transmit commands to a servo 308 adapted to drive effector 302 based on the input commands. Servo 308 may drive effector 302 directly or may drive mechanical linkage 303 or actuator 304. Effector 302 is for example one or more of an aileron, elevator, horizontal stabilizer, flap, slat, spoiler, or rudder. Alternatively, effector 302 may represent an engine control, rotor blade actuator, or proprotor configuration/tilt actuator. Although only one effector 302 is depicted in FIG. 3 for clarity of illustration, in practice system 300 is used to control a plurality of effectors onboard an aircraft.

Pilot interface 301 may be, for example, one or more active inceptor, control wheel, center stick, yoke, cyclic, collective, or other interface located onboard the aircraft or remotely (e.g., by a pilot of an unmanned aerial vehicle (UAV)). In certain embodiments, pilot interface 301 may include a first set of interfaces for a pilot and a second set of interfaces for a copilot (not shown), with the first and second sets of interfaces configured to move in concert via one or more force feedback mechanisms or mechanical linkages (e.g., a roll mechanical linkage and a pitch mechanical linkage). In some embodiments, mechanical linkage 303 includes a known mechanical gearing that mechanically couples pilot interface 301 with servo 308. During autopilot operation, pilot interface 301 may move according to command inputs implemented by autopilot controller 306 via mechanical linkage 303.

The example embodiments discussed below use two joystick-type inceptors to receive pilot inputs; however, it will be understood that inceptors having other configurations may be used to receive pilot commands. For example, four-way trim beep switches may be used as a primary or secondary means for capturing pilot inputs for each axis. In some embodiments, the pilot interface may also include four-way trim beep switches on each inceptor. These four-way trim beep switches function as a secondary means of control, such as for fine control inputs. Additionally, or alternatively, in the case of a failure of the primary inceptor input, such as a jammed joystick, the four-way trim beep switch can be used as a backup means for capturing the pilot's primary flight control inputs for the axes served by the failed inceptor.

One or more sensors 309 are mechanically coupled to pilot interface 301 for measuring a position of pilot interface 301. For example, sensor 309 may be one or more rotary variable differential transformers (RVDTs) used to measure movement of pilot interface 301 (e.g., an inceptor and/or a control stick pivot angle). In certain embodiments, sensor 309 includes a plurality of RVDTs configured as a set for determining an angle in a three-axis (e.g., X, Y, Z) space for commanding aircraft motions. Sensor 309 may also measure rotation of the pilot interface 301 around an input device's axis (e.g., measuring the twisting or rolling rotation of an inceptor independent of any tilting rotation).

Flight controller 307 has a memory 310, including a non-transitory medium for storing software 311, and a processor 312 for executing instructions of software 311. Memory 310 in some embodiments is a memory system that includes both transitory memory such as RAM and non-transitory memory such as, ROM, EEPROM, Flash-EEPROM, magnetic media including disk drives, and optical media. Memory 310 stores software 312 as machine readable instructions executable by processor 312. In certain embodiments, flight controller 307 includes one or more flight computers (e.g., a primary flight computer and a backup flight computer). Flight controller 307 is configured to communicate with pilot interface 301, sensor 309, autopilot controller 306, effector 302, and actuator 304 by one of a wired and/or wireless communication medium. Exemplary instructions of software 311 and/or 314 include control law instructions.

Flight controller 307 may use control laws (CLAWS), which are a set of algorithms and rules implemented in an aircraft's flight control system to manage and control the behavior of the aircraft. These control laws are designed to translate pilot inputs into appropriate control surface movements and engine commands to achieve the desired aircraft performance and stability. CLAWS play a crucial role in ensuring safe and efficient flight operations by providing stability augmentation, flight envelope protection, and handling qualities tailored to different flight regimes. Control laws can vary significantly depending on the type of aircraft and its intended operational profile. For example, in a tiltrotor aircraft, CLAWS might include specific algorithms for transitioning between hover and forward flight modes, managing the tilt of the rotors, and ensuring smooth and safe mode transitions. These control laws are typically implemented in the flight control computer and are continuously updated based on sensor inputs and pilot commands to maintain optimal aircraft performance and safety.

Autopilot controller 306 has a memory 313, including a non-transitory medium for storing software 314, and a processor 315 for executing instructions of software 314. In certain embodiments, autopilot controller 306 includes one or more microprocessor, microcontroller, programmable logic controller, and printed circuit boards. Autopilot controller 306 is adapted to communicate with servo 308 and flight controller 307 by one of a wired and/or wireless communication medium. In certain embodiments, autopilot controller 306 and servo 308 are implemented as an integrated autopilot servo device, such as a roll autopilot servo for driving effector 302 (e.g., a roll spoiler and/or an aileron) for providing roll function. Autopilot controller 307 determines command signals for commanding servo 308 based on a bank angle and/or a roll rate (e.g., from sensor 309 or primary flight controller 307), and in some embodiments, based on air data from controller 307.

Autopilot 306 may be engaged and directed to maintain a commanded state, such as desired heading, airspeed, or altitude, for example. The desired parameter may be input using pilot interface 301 by an onboard or remote pilot. Software instructions 314 include an algorithm that applies a control law to drive the aircraft to the commanded state using autopilot commands to one or more effector 302. Once within the desired parameters, autopilot 306 then maintains that state by generating corrective command signals to effector 302.

In certain embodiments, autopilot controller 306 may lack information about an absolute position of servo 308. As such, a sensor 316 may optionally be coupled with servo 308 for determining a position of servo 308. For example, sensor 316 may be a set of hall-effect sensors positioned around an electrical motor shaft of servo 308 for determining an angular rotation position of the electrical motor shaft. Alternatively, sensor 316 may be coupled to mechanical linkage 303 for determining a position of servo 308. In some embodiments, servo 308 drives both a roll spoiler and an aileron in a coordinated manner for providing roll functionality, and sensor 316 may be used to determine a position of both the roll spoiler and the aileron.

Flight controller 307 and autopilot controller 306 measure a response of the aircraft to commands. In various embodiments, the flight controller 307 and autopilot controller 306 measure the aircraft response by measuring flight parameters, such as, for example, actual altitude, actual rate of climb, actual airspeed, actual heading, and other flight parameters. Such parameters may be measured using, for example, airspeed sensor 317, altitude sensor 318, and heading sensor 319. Sensors 317-319 may be associated with an aircraft pitot static system, compass, GPS, navigation system, accelerometers, etc. Other sensors 320 may also be used to provide aircraft state data to autopilot controller 306 and primary flight controller 307.

Traditional tiltrotor aircraft have conventional flight controls such as a throttle, cyclic, collective, and antitorque pedals. Emerging technologies in aviation seek to implement simplified vehicle operations (SVO) to reduce pilot workload. This would include, for example, doing away with conventional inceptors and replacing them with a much simpler and more intuitive interface. Using automation coupled with human factors best practices can reduce the quantity of trained skills and knowledge that a pilot must acquire to operate an aircraft at the required level of operational safety. The use of automation capabilities can offset pilot training requirements.

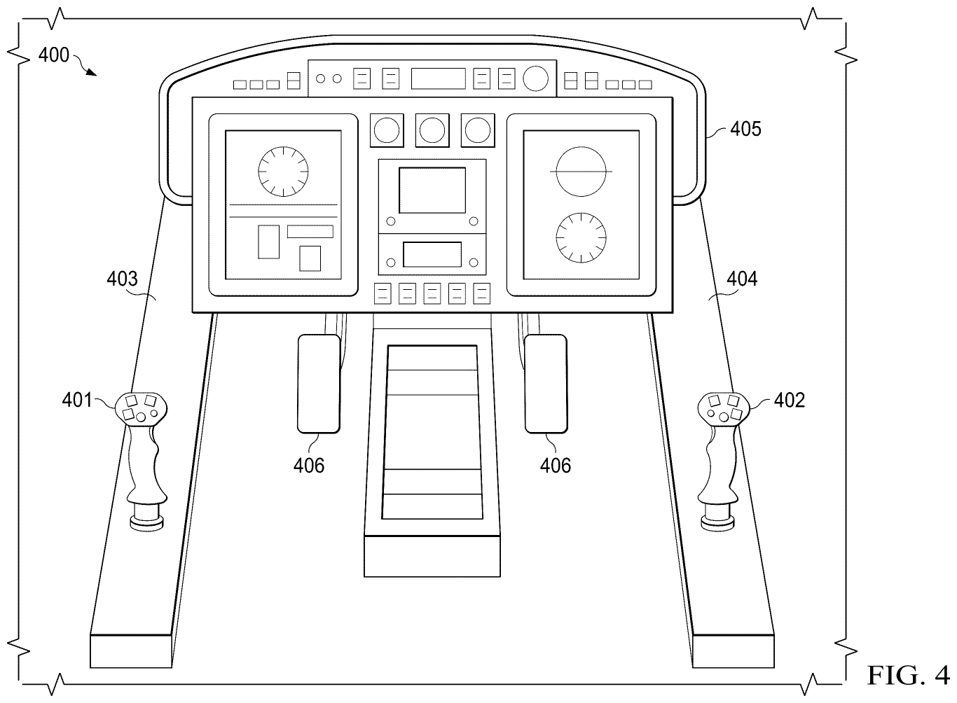

FIG. 4 illustrates an example embodiment of a flight control configuration 400 that allows for SVO. In some embodiments, configuration 400 uses dual sidesticks 401, 402 as the only flight control inputs. Configuration 400 may be used in a cockpit of a tiltrotor aircraft, such as in cockpit 116 or 211 in aircraft 100 or 200. Dual sidesticks 401, 402 may be positioned on side panels or consoles 403, 404 of a cockpit in one configuration. In other configurations, each sidestick 401 and 402 may be mounted on an armrest, pedestal, or other support that enables a pilot to conveniently hold the sidesticks. Configuration 400 is adaptable to a traditional cockpit layout having an instrument/switch panel 405 having any number or types of displays as appropriate for the expected flight conditions and mission of the aircraft. Panel 405 may include switches to control common aircraft functions, such as rotor control, pitot heat, altitude reference, flap control, system test, and the like.

The aircraft control logic is mapped to movement of right-hand (RH) sidestick 401 and left-hand (LH) sidestick 402 in a specific way to provide intuitive and safe operation of the aircraft. Configuration 400 allows for a nominal vector rate configuration as well as a reversionary inceptor mapping. The reversionary inceptor mapping is only required if certain sensor failures occur, which does not allow the vector rate mode to continue operating. The reversionary mode provides a lower level of augmentation to the pilot and is the most direct mode that is possible to control the aircraft. Configuration 400 also provides for automated flight mode changes (i.e., between aircraft hover and cruise modes) for sidesticks 401, 402 as a function of aircraft speed. Configuration 400 removes the need for pedals in the cockpit since yaw and sideslip inputs may be applied by twisting the RH side stick 402. However, in other configurations, yaw and sideslip inputs may be applied using pedals 406.

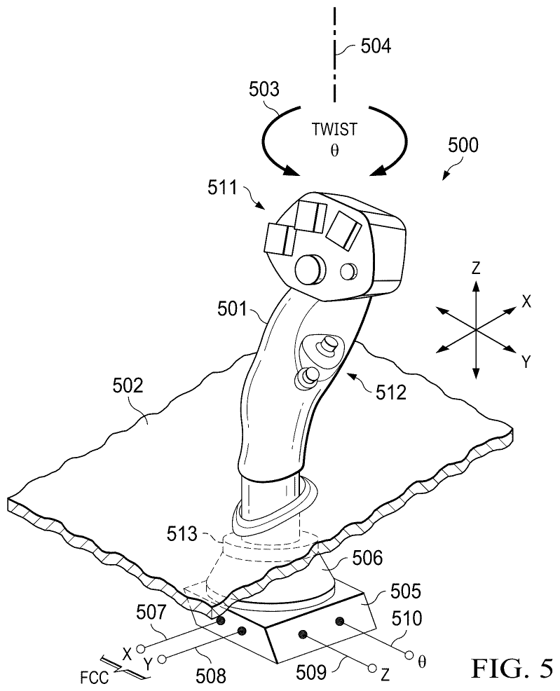

FIG. 5 is a perspective view of an illustrative example of an inceptor 500 that may be used with embodiments disclosed herein. Inceptor 500 be referred to as a sidestick, control stick, controller, or flight command input in other arrangements. Inceptor 500 function as a flight control, such as sidesticks 401, 402 in a fly-by-wire a tiltrotor aircraft. In this example, inceptor 500 includes a stick grip 501 that can be held in the hand of a pilot. The example inceptor 500 is adapted for a left hand, but grip 501 may be configured to be held in either a left or right hand. Grip 501 may provide multiple degrees of freedom of movement, such as movement in the X and Y directions (i.e., longitudinally, and laterally). In some arrangements, inceptor 500 may also detect movement in the Z direction (i.e., push grip 501 toward or pull grip 501 away from console panel 502). In other arrangements, inceptor may further detect rotation of grip 501, such as a twisting motion 503 around axis 504. The rotation of grip 501 may be measured as an angle θ relative to a neutral or reference position.

In an example configuration, inceptor 500 is mounted on a sensor array 505 that detects rotation of grip 501 around a spherical mount 506 in the X and Y directions. Sensor array 505 generates corresponding digital or analog signals representing the respective movement in the X and Y directions and outputs those signals 507, 508 to an FCC, FBW system, Flight Control System (FCS), or other component. Sensor array 506 may also be configured to measure movement of grip 501 in the Z direction and a rotation angle θ corresponding to twisting of grip 501. Sensor array 505 generates corresponding digital or analog signals representing the movement in the Z direction and the rotation angle θ and outputs those signals 509, 510 to the FBW system or any other appropriate aircraft system. For example, movement in the Z direction and the rotation angle θ may be used to control cockpit displays, navigation systems, communication systems, or other components instead of providing flight control inputs.

Inceptor 500 may have additional inputs, such as discrete switches, trim switches, buttons, and thumbwheels 511, 512, that are used for functions including navigation, communication, aircraft trim, auxiliary equipment operation (e.g., spotlights, winches, etc.), weapon selection or release, and the like. For example, a four-way discrete switch with pushbutton inputs may accept up, down, left, and right trim inputs along with trim select/reset inputs. A two-way discrete rocker thumbwheel may accept up/down manual conversion inputs.

Although the example inceptor 500 is shown as configured for pivoting motion around a spherical mount 506, in other arrangements inceptor 500 may move in a sliding motion in one or more direction or degree of freedom. For example, inceptor 500 may move longitudinally along a slot in console panel 502 (not shown) to provide a Y input while capable of rotating laterally around mount 506 to provide an X input.

The inceptor 500 may sense inputs as actual movement of the inceptor or as a force applied to the inceptor. It will be understood that, when the present disclosure refers to force or pressure applied to an inceptor, movement of the inceptor may or may not occur.

Inceptor 500 may be a passive inceptor with a fixed force/feel characteristic that is provided by springs and dampers. The passive inceptor does not provide tactile cues about the airplane current situation to the pilot holding grip 501. Flight control systems that use passive sidesticks rely on the flight control laws within the aircraft's FCC or FBW system to keep the aircraft within a safe operating envelope. The flight control system does not allow the aircraft's limits to be exceeded no matter what inputs a pilot applies to the system via the side sticks.

In another embodiment, inceptor 500 is an active inceptor that has a servo-actuator mechanism that provides a force/feel characteristic to the grip 501. For example, sensor array 505 may be configured to provide force/feel feedback to grip 501 using a feedback generator 513. For example, when grip 501 is displaced in the X or Y direction from a neutral position, a pilot may feel a resistive force (i.e., tactile feedback) tending to return the grip 501 to the neutral position. The resistive force created by the feedback generator 513 may be constant through the entire range of movement of grip 501, or the resistive force may increase as the displacement of grip 501 increases so that more force is required to move grip 501 as it gets farther from the neutral position in angle, distance, or range. The variable force/feel characteristic can be varied throughout the range of motion of grip 501 and hence this function can be used to provide tactile cues to the pilot that are pertinent to a current flight condition. The relevant force/feel commands are chosen to provide the correct feel depending on the flight condition. The force/feel characteristic may be continuously updated by the FCC or FBW system in real-time to reflect the current aircraft situation or the force/feel characteristic may be dependent only upon the amount or degree of deflection of grip 501.

Additional tactile feedback may be provided to a pilot via inceptor 500 using feedback generator 513. For example, feedback signals such as a vibration, buzz, shake, or judder may be triggered when the aircraft is in or approaching an unsafe flight condition or may be initiated as notification of some event related to the aircraft navigation, communication, or other systems.

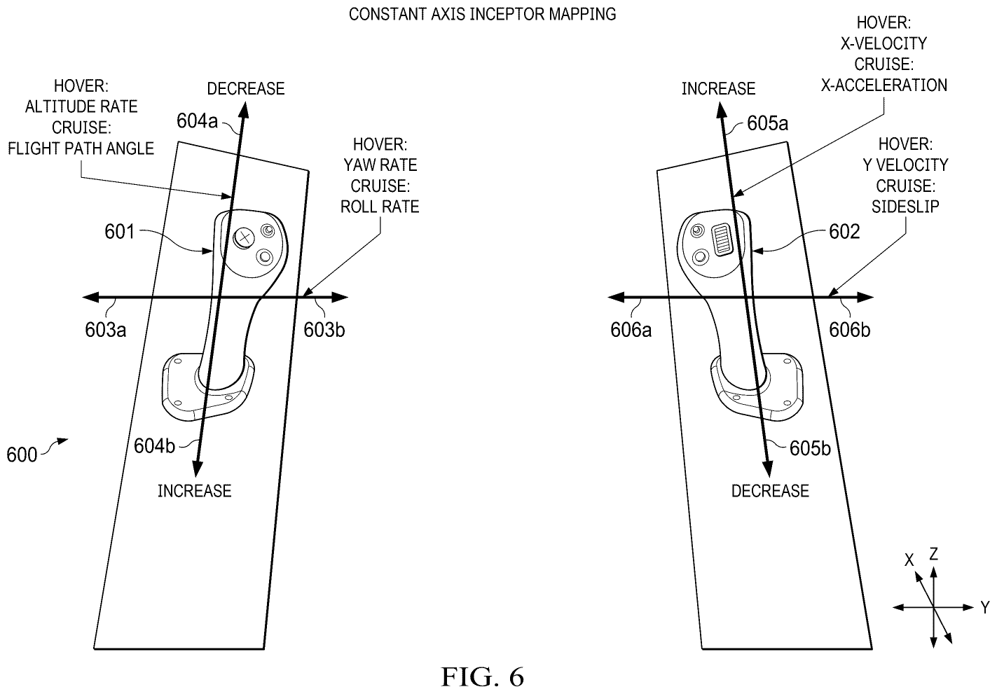

FIG. 6 illustrates an inceptor mapping 600 for a constant axis mode of aircraft operation. Two inceptors 601, 602 are used in mapping 600. The advantage of this inceptor mapping is that it appeals to both rotorcraft and fixed wing pilots. In hover flight mode, the longitudinal and lateral aircraft control is on RH stick 602 while the LH stick 601 functions are closer to a collective lever (i.e., pull to go up). In cruise flight mode, the LH stick 601 commands both flight path angle and roll rate while the RH stick 602 functions as a speed or acceleration lever. The concept includes the idea of a “Turn Stick”-meaning that inputs along the LH lateral axis 603a,b will always result in an aircraft heading change regardless of flight mode. In hover flight mode, the aircraft heading change is accomplished by commanding a yaw rate, and in cruise flight mode the aircraft heading change is accomplished by producing a roll rate, which subsequently results in a heading change. LH inceptor 601 receives pilot's altitude inputs in response to longitudinal forces 604a,b applied along the aircraft's x-axis.

RH inceptor 602 receives longitudinal velocity and acceleration inputs in response to forces 605a,b applied along the aircraft's x-axis. RH inceptor 602 receives lateral velocity inputs in response to forces 605a,b applied along the aircraft's y-axis 606.

The transition between hover and forward flight may be a discrete switch between modes at a defined speed or can be blended between modes.

TABLE 1
CONSTANT AXIS INCEPTOR MAPPING

| | HOVER | CRUISE | |
|---|---|---|---|
| | FLIGHT | FLIGHT | GENERAL |
| INCEPTOR/INPUT | MODE | MODE | NAME |
| RH Inceptor/ | X-Velocity | X-Acceleration | Forward-Back |
| Longitudinal | | | Stick |
| Force | | | |
| (Forward+) | | | |
| RH Inceptor/ | Y-Velocity | Sideslip Angle | Skid |
| Lateral Force | | | Stick |
| LH Inceptor/ | Yaw Rate | Roll Rate | Turn |
| Lateral Force | | | Stick |
| LH Inceptor/ | Altitude Rate | Flight Path | Climb- |
| Longitudinal | | Angle Rate | Descend |
| Force | | | Stick |
| (Aft+) | | | |

An aircraft's flight control system may enter a reversionary mode when certain sensor failures or system malfunctions occur. The reversionary mode is a backup or fallback mode that is activated when malfunctions prevent the primary control mode (such as vector rate mode) from operating correctly. In reversionary mode, the flight control system provides a lower level of augmentation to the pilot, which requires more manual control of the aircraft's attitude and thrust. In reversionary mode, the pilot must command roll and pitch attitude directly, as well as manually controlling conversion angle and commanded thrust for the propulsion systems. The reversionary mode is designed to be the most direct and fundamental way to control the aircraft, ensuring that the pilot can maintain control even in the event of significant system failures.

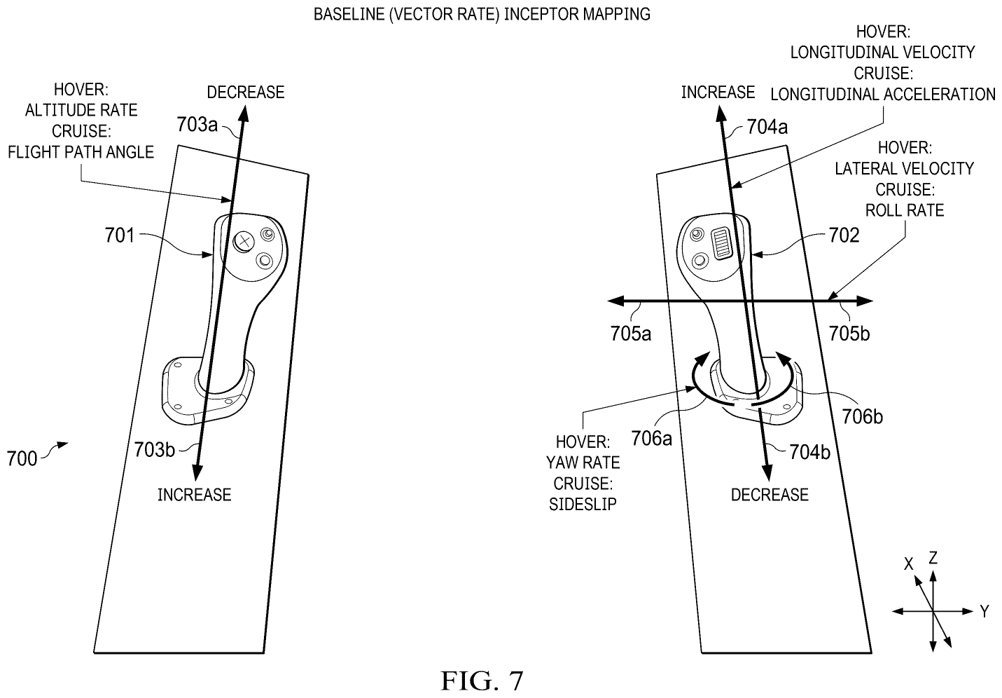

Various inceptor mappings may be used both for the vector rate mode and the reversionary mode as described with reference to FIGS. 7-12 below. In a two-inceptor cockpit configuration as shown in FIG. 4, selected inputs from each inceptor may be associated with the input axis commands (i.e., a designated x-, y-, or z-axis, or twist input on an inceptor provides an altitude, longitudinal, lateral, or directional command.

The transition between hover flight mode and cruise flight mode is determined by the forward velocity of the aircraft. For some inceptor inputs (e.g., the longitudinal and lateral inputs), the control transition speed may be determined by the aircraft's ground speed, such as a discrete transition at a defined speed or a blended transition between hover flight mode and cruise flight mode. For other inceptor inputs (e.g., the altitude and directional inputs), the control transition speed may be determined by the aircraft's Knots Calibrated Airspeed (KCAS), which is a measure of an aircraft's speed relative to the surrounding air, corrected for instrument and position errors. In some configurations, a specific ground speed or airspeed may be designated as the transition point between the hover mode and cruise mode. In other configurations, different airspeeds may be set for transitioning between modes depending upon whether the aircraft is accelerating or decelerating.

When operating under a vector rate command mode, the inceptor input for altitude while in hover flight mode will control the aircraft's vertical rate (or altitude rate). As the aircraft transitions to cruise flight mode, the altitude inceptor input will transition to control the aircraft's flight path rate. When operating in the reversionary command mode, the altitude inceptor either directly controls thrust or pitch depending on the configuration. The autonomy/hold function for the altitude inceptor inputs will maintain aircraft altitude in both the hover mode and cruise mode.

The longitudinal inceptor input while in hover flight mode will control the aircraft's longitudinal velocity when operating under vector rate command mode. As the aircraft transitions to cruise flight mode, the longitudinal inceptor input will transition to control the aircraft's longitudinal acceleration. When operating in the reversionary command mode, the longitudinal inceptor inputs directly control either thrust or pitch depending on configuration. The autonomy/hold function for the longitudinal inceptor will maintain position over the ground in hover flight mode and will maintain longitudinal velocity (airspeed) while in cruise flight mode.

The lateral inceptor input while in hover flight mode will control the aircraft's lateral velocity when operating under vector rate command mode. As the aircraft transitions to cruise flight mode, the lateral inceptor input will transition to control the aircraft's roll attitude. When operating in the reversionary command mode, the lateral inceptor inputs will control the aircraft's roll attitude in both the hover mode and cruise mode. The autonomy/hold function for the lateral inceptor inputs in hover mode is to maintain aircraft position. The autonomy/hold function for the lateral inceptor input in cruise mode is to maintain aircraft heading.

When operating under vector rate command mode, the directional inceptor input while in hover flight mode will control the aircraft's yaw rate. As the aircraft transitions to cruise flight mode, the directional inceptor input will transition to control the aircraft's sideslip. When operating in the reversionary command mode, the directional inceptor input function does not change between vector rate and attitude direct, it is always commanding yaw rate. The autonomy/hold function for the directional inceptor inputs in hover mode is to maintain aircraft heading. There is no autonomy/hold function for the directional inceptor inputs in cruise mode.

FIG. 7 illustrates a baseline inceptor mapping 700 for a vector rate mode of aircraft operation. Two inceptors 701, 702 are used in mapping 700. The baseline inceptor mapping 700 is used while the aircraft flight control laws (CLAWS) are in vector rate mode, which is the nominal mode for normal aircraft operation. The mapping for inceptors 701, 702 unifies the longitudinal and vertical axis such that the pilot will always be commanding longitudinal speed/acceleration with a single inceptor axis and will always be commanding their climb/descent rate with another inceptor axis.

LH inceptor 701 receives the pilot's altitude inputs in response to forces 703a,b applied along the aircraft's x-axis. RH inceptor 702 receives longitudinal inputs in response to forces 704a,b applied along the aircraft's x-axis, receives lateral inputs in response to forces 705a,b applied along the aircraft's y-axis 706, and receives directional inputs in response to twisting forces 706a,b applied around the aircraft's z-axis.

In baseline vector mapping 700, during hover flight mode, the aircraft's altitude is controlled using LH inceptor 701 and longitudinal velocity, lateral velocity, and yaw rate are controlled using RH inceptor 702. During cruise flight mode, the aircraft's flight path angle (i.e., pitch) is controlled using LH inceptor 701 and longitudinal acceleration, roll rate, and sideslip are controlled using RH inceptor 702. Forward force 703a on LH inceptor 701 is a negative altitude/pitch input and backward force 703b is a positive altitude/pitch input. On the other hand, forward force 704a on RH inceptor 702 is a positive velocity/acceleration input and backward force 704b is a negative velocity/acceleration input.

LH inceptor 701 and RH inceptor 702 may accept additional inputs from the pilot, such as such as a lateral force (aircraft y-axis), vertical force (aircraft z-axis), and twisting force (around the aircraft z-axis) applied to LH inceptor 701 and/or a vertical force applied to RH inceptor 702. These additional inputs are not used as flight control commands. The unmapped inputs may instead be used to control other aircraft systems, such as navigation or avionics systems.

The flight speed at which the mode switch occurs between hover and forward flight control methodologies differs depending on the axis and is detailed in Table 2 below, which shows the baseline inceptor mapping by flight phase. The X-velocity and Y-velocity commands will switch to X-acceleration and roll rate commands, respectively, either at a discrete airspeed or the transition may be blended.

TABLE 2
BASELINE VECTOR RATE INCEPTOR MAPPING

| | HOVER | CRUISE | |
|---|---|---|---|
| | FLIGHT | FLIGHT | GENERAL |
| INCEPTOR/INPUT | MODE | MODE | NAME |
| RH Inceptor/ | X-Velocity | X-Acceleration | Forward-Back |
| Longitudinal | | | Stick |
| Force | | | |
| (Forward+) | | | |
| RH Inceptor/ | Y-Velocity | Roll Rate | Roll |
| Lateral Force | | | Stick |
| RH Inceptor/ | Yaw Rate | Sideslip Angle | Yaw Stick |
| Twist Force | | | Twist |
| LH Inceptor/ | Altitude Rate | Flight Path | Climb- |
| Longitudinal | | Angle Rate | Descend |
| Force | | | Stick |
| (Aft+) | | | |

An aircraft's flight control system may enter a reversionary mode when certain sensor failures or system malfunctions occur. The reversionary mode is a backup or fallback mode that is activated when malfunctions prevent the primary control mode (such as vector rate mode) from operating correctly. In reversionary mode, the flight control system provides a lower level of augmentation to the pilot, which requires more manual control of the aircraft's attitude and thrust. In reversionary mode, the pilot must command roll and pitch attitude directly, as well as manually controlling conversion angle and commanded thrust for the propulsion systems. The reversionary mode is designed to be the most direct and fundamental way to control the aircraft, ensuring that the pilot can maintain control even in the event of significant system failures.

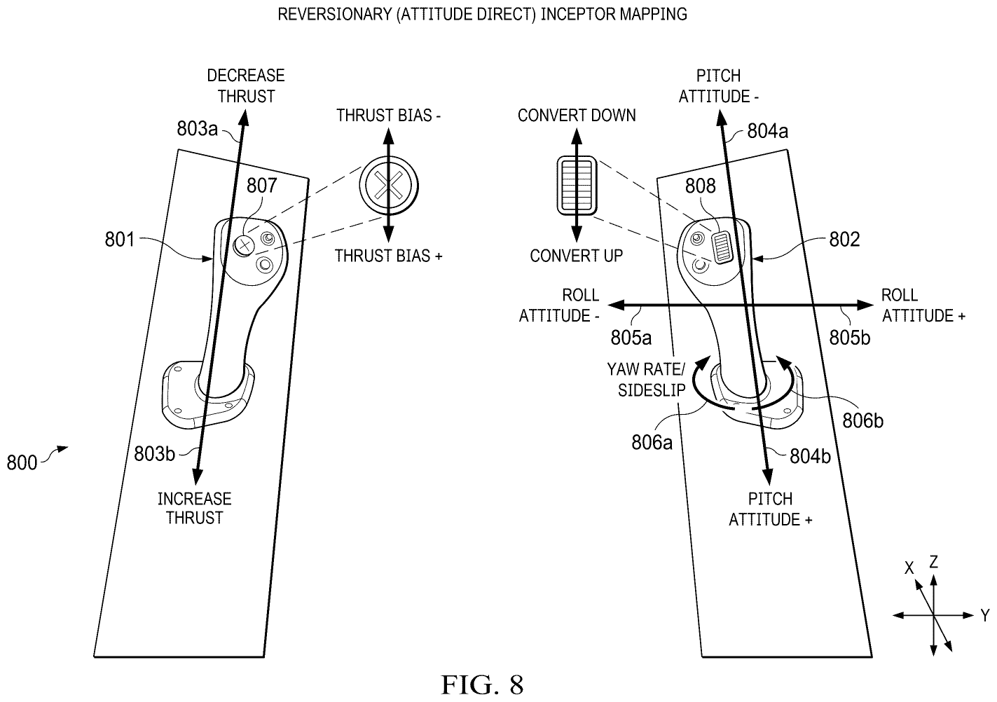

FIG. 8 illustrates a baseline inceptor mapping 800 for a reversionary mode of aircraft operation. The two inceptors 801, 802 used in mapping 800 are the same physical inceptors 701, 702 used in the baseline vector rate mode; however, the aircraft reacts in a different way to reversionary inceptors 801, 802 compared to the vector rate mode. The baseline reversionary mode mapping 800 is used while the aircraft CLAWS enter the reversionary attitude-direct mode. In this mode the CLAWS still provide augmentation but to a lower level. The pilot must command roll and pitch attitude directly as well as manually control conversion angle and commanded thrust. This setup ensures that the pilot can still manage the essential flight parameters even if the primary control systems are compromised.

In the reversionary mode, LH inceptor 801 controls thrust offset and thrust bias. LH inceptor 801 receives the pilot's inputs applied along the aircraft's x-axis to decrease 803a or increase 803b thrust. The LH thrust-control inceptor 801 will increase or decrease the commanded thrust from a set point. When inceptor 801 is returned to detent, the commanded thrust will equal a set point. The set point is set using a thrust bias switch 807, such as a four-way trim beep switch on LH inceptor 801. The set point may be biased in either direction using the thrust bias switch 807. Forward pressure, clicks, or beeps on the thrust bias switch 807 are negative thrust inputs and backward pressure, clicks, or beeps on the thrust bias switch 807 are positive thrust inputs.

RH inceptor 802 controls pitch attitude, roll attitude, and yaw rate or sideslip angle. Forward force 804a is a negative pitch attitude input, and backward force 804b is a positive pitch attitude input. Left and right lateral forces 805a,b are roll attitude inputs. Left and right twisting forces 806a,b provide yaw rate inputs while in hover flight mode and provide sideslip inputs while in cruise flight mode. A two-way discrete switch 808 on RH inceptor 802 is a conversion command input and is used to command the rotation of the propulsion systems. Forward pressure on the conversion command switch 808 is a negative conversion input (i.e., convert down), and backward pressure on the conversion command switch 808 is a positive conversion input (i.e., convert up).

Table 3 below shows the reversionary attitude-direct inceptor mapping by flight phase. There is no conversion transition for the flight control system in this reversionary mode. Instead, the pilot manually controls the tilt of the propulsion systems using the conversion control switch 808 on the RH inceptor 802.

TABLE 3
BASELINE REVERSIONARY ATTITUDE-
DIRECT INCEPTOR MAPPING

| | HOVER | CRUISE | |
|---|---|---|---|
| | FLIGHT | FLIGHT | GENERAL |
| INCEPTOR/INPUT | MODE | MODE | NAME |
| RH Inceptor/ | Pitch Attitude | Pitch Attitude | Pitch Stick |
| Longitudinal Force | | | |
| (Aft+) | | | |
| RH Inceptor/ | Roll Attitude | Roll Attitude | Roll Stick |
| Lateral Force | | | |
| RH Inceptor/ | Yaw Rate | Sideslip Angle | Yaw Stick Twist |
| Twist Force | | | |
| LH Inceptor/ | Thrust Offset | Thrust Offset | Thrust Lever |
| Longitudinal | | | |
| Force (Aft+) | | | |
| LH Inceptor/ | Thrust Bias | Thrust Bias | Thrust Set Point |
| Thrust Beep | | | |
| Switch (Aft+) | | | |
| RH Inceptor/ | Conversion | Conversion | Conversion |
| Two-Way Discrete | Command | Command | Command |
| Switch | | | |

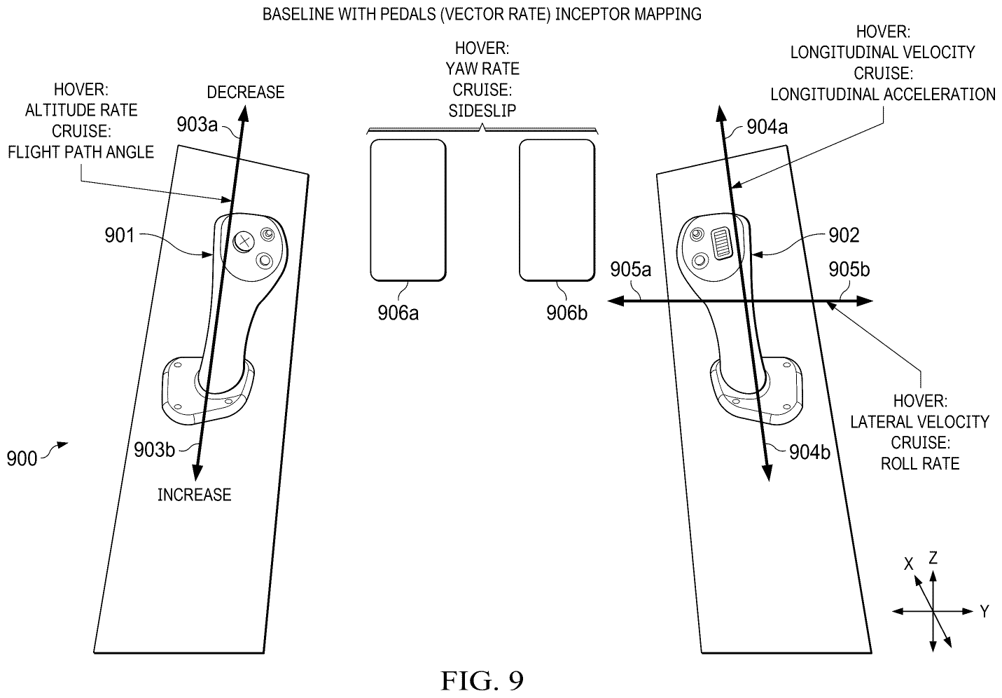

FIG. 9 illustrates an alternative baseline inceptor mapping 900 for a vector rate mode of aircraft operation. In addition to inceptors 901, 902 mapping 900 also uses floor pedals 906a,b. This alternative configuration maintains the same inceptor stick functions as the baseline configuration described in connection with FIG. 7 but the yaw functionality is moved from the RH inceptor twist input to floor-mounted pedals 906a,b.

LH inceptor 901 receives the pilot's altitude inputs in response to forces 903a,b applied along the aircraft's x-axis. RH inceptor 902 receives longitudinal inputs in response to forces 904a,b applied along the aircraft's x-axis and receives lateral inputs in response to forces 905a,b applied along the aircraft's y-axis. Floor pedals 906a,b and receives directional inputs in response to force applied to the left or right pedal.

The flight speed at which the mode switch occurs between hover and forward flight control methodologies differs depending on the axis and is detailed in Table 4 below, which shows the alternative baseline inceptor mapping with floor pedals by flight phase.

TABLE 4
BASELINE (PEDALS) VECTOR RATE INCEPTOR MAPPING

| | HOVER | CRUISE | |
|---|---|---|---|
| | FLIGHT | FLIGHT | GENERAL |
| INCEPTOR/INPUT | MODE | MODE | NAME |
| RH Inceptor/ | X-Velocity | X-Acceleration | Forward-Back |
| Longitudinal | | | Stick |
| Force | | | |
| (Forward+) | | | |
| RH Inceptor/ | Y-Velocity | Roll Rate | Roll |
| Lateral Force | | | Stick |
| Floor Pedals | Yaw Rate | Sideslip Angle | Rudder Pedals |
| LH Inceptor/ | Altitude Rate | Flight Path | Climb- |
| Longitudinal | | Angle Rate | Descend |
| Force | | | Stick |
| (Aft+) | | | |

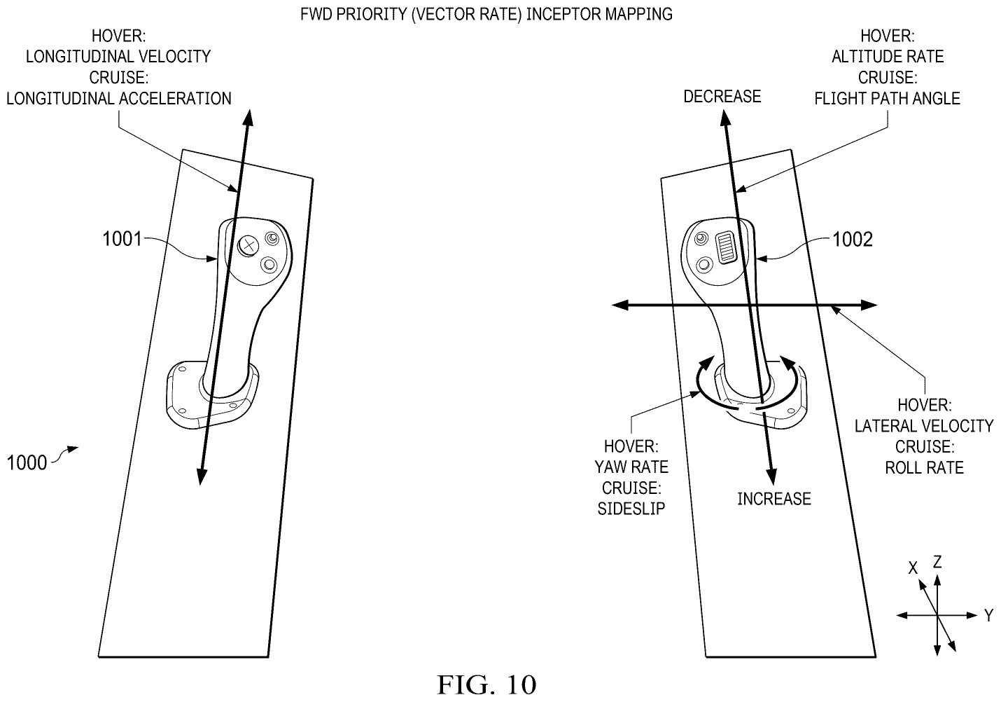

FIG. 10 illustrates another alternative inceptor mapping 1000. This configuration is a vector rate mode with forward priority. The alternative mapping configuration 1000 maintains the same inceptor stick functions as the baseline vector rate configuration described in connection with FIG. 7 but with the longitudinal functionality of both of the LH and RH inceptors swapped. In this configuration, the LH inceptor 1001 longitudinal axis is now the “Forward-Back” Stick, and the RH inceptor 1002 longitudinal axis is now the “Climb-Descend” stick.

The flight speed at which the mode switch occurs between hover and forward flight control methodologies differs depending on the axis and is detailed in Table 5 below, which shows the baseline inceptor mapping by flight phase.

TABLE 5
FORWARD PRIORITY VECTOR RATE INCEPTOR MAPPING

| | HOVER | CRUISE | |
|---|---|---|---|
| | FLIGHT | FLIGHT | GENERAL |
| INCEPTOR/INPUT | MODE | MODE | NAME |
| LH Inceptor/ | X-Velocity | X-Acceleration | Forward-Back |
| Longitudinal | | | Stick |
| Force | | | |
| (Forward+) | | | |
| RH Inceptor/ | Y-Velocity | Roll Rate | Roll |
| Lateral Force | | | Stick |
| RH Inceptor/ | Yaw Rate | Sideslip Angle | Yaw Stick |
| Twist Force | | | Twist |
| RH Inceptor/ | Altitude Rate | Flight Path | Climb- |
| Longitudinal | | Angle Rate | Descend |
| Force | | | Stick |
| (Aft+) | | | |

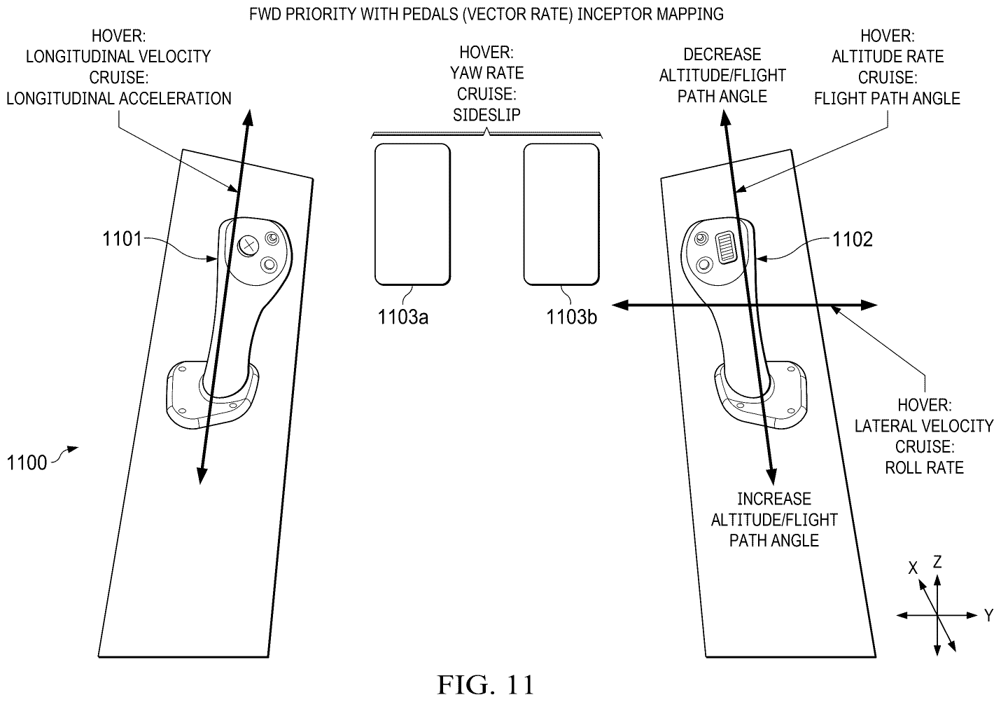

FIG. 11 illustrates an alternative baseline inceptor mapping 1100 for a vector rate mode with forward priority. In addition to inceptors 1101, 1102 mapping 1100 also uses floor pedals 1103a,b. This alternative configuration maintains the same inceptor stick functions as the forward priority configuration described in connection with FIG. 10 but the yaw functionality is moved from the RH inceptor twist input to floor-mounted pedals 1103a,b.

Table 6 provides the mapping for the forward priority vector rate configuration with floor pedals and the speed at which the mode switch occurs between hover and forward flight.

TABLE 6
FORWARD PRIORITY (PEDALS) VECTOR
RATE INCEPTOR MAPPING

| | HOVER | CRUISE | |
|---|---|---|---|
| | FLIGHT | FLIGHT | GENERAL |
| INCEPTOR/INPUT | MODE | MODE | NAME |
| LH Inceptor/ | X-Velocity | X-Acceleration | Forward-Back |
| Longitudinal | | | Stick |
| Force | | | |
| (Forward+) | | | |
| RH Inceptor/ | Y-Velocity | Roll Rate | Roll |
| Lateral Force | | | Stick |
| Floor Pedals | Yaw Rate | Sideslip Angle | Rudder Pedals |
| RH Inceptor/ | Altitude Rate | Flight Path | Climb- |
| Longitudinal | | Angle Rate | Descend |
| Force | | | Stick |
| (Aft+) | | | |

As noted above, an aircraft's flight control system may enter a reversionary mode when certain sensor failures or system malfunctions occur. The reversionary mode is a backup or fallback mode that is activated when malfunctions prevent the primary control mode (such as vector rate mode) from operating correctly.

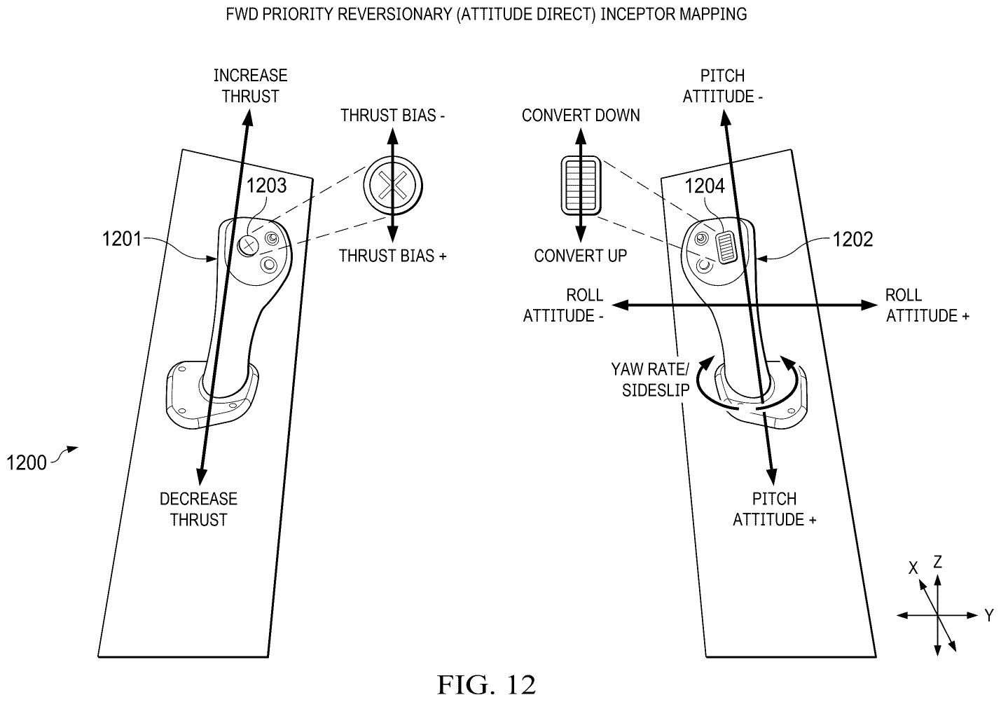

FIG. 12 illustrates a forward priority inceptor mapping 1200 for a reversionary mode of aircraft operation. In the reversionary mode, LH inceptor 1201 controls thrust offset and thrust bias, and RH inceptor 1202 controls pitch attitude, roll attitude, and yaw rate or sideslip angle.

The LH thrust-control inceptor 1201 will increase or decrease the commanded thrust from a set point, wherein forward force on LH inceptor 1201 signals is a positive signal to increase thrust. When LH inceptor 1201 is returned to detent, the commanded thrust will equal a set point. The set point is set using a thrust bias switch 1203, such as a four-way trim beep switch on LH inceptor 1201. The set point may be biased in either direction using the thrust bias switch 1203. Forward pressure, clicks, or beeps on the thrust bias switch 1203 are negative thrust bias inputs and backward pressure, clicks, or beeps on the thrust bias switch 1203 are positive thrust bias inputs.

Forward force on RH inceptor 1202 is a negative pitch attitude input. Left and right lateral forces are roll attitude inputs. Left and right twisting forces provide yaw rate inputs while in hover flight mode and provide sideslip inputs while in cruise flight mode. A two-way discrete switch 1204 on RH inceptor 1202 is a conversion command input and is used to command the rotation of the propulsion systems. Forward pressure on the conversion command switch 1204 is a negative conversion input (i.e., convert down), and backward pressure on the conversion command switch 808 is a positive conversion input (i.e., convert up).

Table 7 below shows the reversionary attitude-direct inceptor mapping by flight phase for the forward priority configuration mapping. There is no conversion transition for the flight control system in this reversionary mode. Instead, the pilot manually controls the tilt of the propulsion systems using the conversion control switch 1204 on the RH inceptor 1202.

TABLE 7
FORWARD PRIORITY REVERSIONARY ATTITUDE-
DIRECT INCEPTOR MAPPING

| | HOVER | CRUISE | |
|---|---|---|---|
| | FLIGHT | FLIGHT | GENERAL |
| INCEPTOR/INPUT | MODE | MODE | NAME |
| RH Inceptor/ | Pitch Attitude | Pitch Attitude | Pitch Stick |
| Longitudinal Force | | | |
| (Aft+) | | | |
| RH Inceptor/ | Roll Attitude | Roll Attitude | Roll Stick |
| Lateral Force | | | |
| RH Inceptor/ | Yaw Rate | Sideslip Angle | Yaw Stick Twist |
| Twist Force | | | |
| LH Inceptor/ | Thrust Offset | Thrust Offset | Thrust Lever |
| Longitudinal Force | | | |
| (Aft+) | | | |
| LH Inceptor/ | Thrust Bias | Thrust Bias | Thrust Set Point |
| Thrust Beep Switch | | | |
| (AFT+) | | | |
| RH Inceptor/ | Conversion | Conversion | Conversion |
| Two-Way Discrete | Command | Command | Command |
| Switch | | | |

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be haracteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

The diagrams in the Figures illustrate the architecture, functionality, and/or operation of possible implementations of various embodiments of the present disclosure. Although several embodiments have been illustrated and described in detail, numerous other changes, substitutions, variations, alterations, and/or modifications are possible without departing from the spirit and scope of the present disclosure, as defined by the appended claims.

The particular embodiments described herein are illustrative only and may be modified and practiced in different but equivalent manners, as would be apparent to those of ordinary skill in the art having the benefit of the teachings herein. Those of ordinary skill in the art would appreciate that the present disclosure may be readily used as a basis for designing or modifying other embodiments for carrying out the same purposes and/or achieving the same advantages of the embodiments introduced herein. For example, certain embodiments may be implemented using more, less, and/or other components than those described herein. Moreover, in certain embodiments, some components may be implemented separately, consolidated into one or more integrated components, and/or omitted. Similarly, methods associated with certain embodiments may be implemented using more, less, and/or other steps than those described herein, and their steps may be performed in any suitable order.

Numerous other changes, substitutions, variations, alterations, and modifications may be ascertained to one of ordinary skill in the art and it is intended that the present disclosure encompass all such changes, substitutions, variations, alterations, and modifications as falling within the scope of the appended claims.

One or more advantages mentioned herein do not in any way suggest that any one of the embodiments described herein necessarily provides all the described advantages or that all the embodiments of the present disclosure necessarily provide any one of the described advantages. Note that in this Specification, references to various features included in “one embodiment,” “example embodiment,” “an embodiment,” “another embodiment,” “certain embodiments,” “some embodiments,” “various embodiments,” “other embodiments,” “alternative embodiment,” and the like are intended to mean that any such features are included in one or more embodiments of the present disclosure but may or may not necessarily be combined in the same embodiments.

As used herein, unless expressly stated to the contrary, use of the phrase “at least one of,” “one or more of” and “and/or” are open ended expressions that are both conjunctive and disjunctive in operation for any combination of named elements, conditions, or activities. Additionally, unless expressly stated to the contrary, the terms “first,” “second,” “third,” etc., are intended to distinguish the particular nouns (e.g., blade, rotor, element, device, condition, module, activity, operation, etc.) they modify. Unless expressly stated to the contrary, the use of these terms is not intended to indicate any type of order, rank, importance, temporal sequence, or hierarchy of the modified noun. For example, “first X” and “second X” are intended to designate two X elements that are not necessarily limited by any order, rank, importance, temporal sequence, or hierarchy of the two elements. As referred to herein, “at least one of,” “one or more of,” and the like can be represented using the “(s)” nomenclature (e.g., one or more element(s)).

What is claimed is:

1. A flight control system for a tiltrotor aircraft, comprising:
a plurality of propulsion systems each independently tiltable between a vertical position and a horizontal position by aircraft effectors; and
a flight control computer configured to control the tiltrotor aircraft effectors in response to inputs from inceptors, the flight control computer comprising one or more processors and a memory, wherein the memory stores instructions for controlling aircraft effectors, the instructions causing the flight control computer to perform the steps of:
receive inputs from a first inceptor and a second inceptor; and
apply flight control laws to map the inputs to command longitudinal and vertical movement of the tiltrotor aircraft,
wherein the first inceptor inputs command longitudinal speed and acceleration of the tiltrotor aircraft in both a hover flight mode and a cruise flight mode, and the second inceptor inputs command climb and descent rates in both hover and cruise flight modes.

2. The flight control system of claim 1, wherein the instructions further causing the flight control computer to perform the steps of:
converting a signal representing a longitudinal force applied to the first inceptor into an altitude rate change in hover flight mode or into a flight path angle change in cruise flight mode;
converting a signal representing a longitudinal force applied to the second inceptor into a longitudinal velocity in hover flight mode or into a longitudinal acceleration in cruise flight mode;
converting a signal representing a lateral force applied to the second inceptor into a lateral velocity in hover flight mode or into a roll rate in cruise flight mode; and
converting a signal representing a twist force applied to the second inceptor into a yaw rate command in hover flight mode or into a sideslip command in cruise flight mode.

3. The flight control system of claim 1, wherein the instructions further causing the flight control computer to perform the steps of:
converting a signal representing a longitudinal force applied to the first inceptor into a thrust offset command, wherein forward-directed forces correspond to a thrust decrease and backward-directed forces correspond to a thrust increase;
converting signals from a switch on the first inceptor into a thrust bias setting;
converting a signal representing a longitudinal force applied to the second inceptor into a pitch attitude command;
converting a signal representing a lateral force applied to the second inceptor into a roll attitude command;
converting a signal representing a twist force applied to the second inceptor into a yaw rate command; and
converting signals from a switch on the second inceptor into a conversion command.

4. The flight control system of claim 1, wherein the instructions further causing the flight control computer to perform the steps of:
converting a signal representing a longitudinal force applied to the first inceptor into an altitude rate change in hover flight mode or into a flight path angle change in cruise flight mode;
converting a signal representing a longitudinal force applied to the second inceptor into a longitudinal velocity in hover flight mode or into a longitudinal acceleration in cruise flight mode;
converting a signal representing a lateral force applied to the second inceptor into a lateral velocity in hover flight mode or into a roll rate in cruise flight mode; and
converting signals representing forces applied to floor pedals into a yaw rate command in hover flight mode or into a sideslip command in cruise flight mode.

5. The flight control system of claim 1, wherein the instructions further causing the flight control computer to perform the steps of:
converting a signal representing a longitudinal force applied to the first inceptor into a longitudinal velocity in hover flight mode or into a longitudinal acceleration in cruise flight mode;
converting a signal representing a longitudinal force applied to the second inceptor into;
an altitude rate change in hover flight mode or into a flight path angle change in cruise flight mode;
converting a signal representing a lateral force applied to the second inceptor into a lateral velocity in hover flight mode or into a roll rate in cruise flight mode; and
converting a signal representing a twist force applied to the second inceptor into a yaw rate command in hover flight mode or into a sideslip command in cruise flight mode.

6. The flight control system of claim 1, wherein the instructions further causing the flight control computer to perform the steps of:
converting a signal representing a longitudinal force applied to the first inceptor into a longitudinal velocity in hover flight mode or into a longitudinal acceleration in cruise flight mode;
converting a signal representing a longitudinal force applied to the second inceptor into;
an altitude rate change in hover flight mode or into a flight path angle change in cruise flight mode;
converting a signal representing a lateral force applied to the second inceptor into a lateral velocity in hover flight mode or into a roll rate in cruise flight mode; and
converting signals representing forces applied to floor pedals into a yaw rate command in hover flight mode or into a sideslip command in cruise flight mode.

7. The flight control system of claim 1, wherein the instructions further causing the flight control computer to perform the steps of:
converting a signal representing a longitudinal force applied to the first inceptor into a thrust offset command, wherein forward-directed forces correspond to a thrust increase and backward-directed forces correspond to a thrust decrease;
converting signals from a switch on the first inceptor into a thrust bias setting;
converting a signal representing a longitudinal force applied to the second inceptor into a pitch attitude command;
converting a signal representing a lateral force applied to the second inceptor into a roll attitude command;
converting a signal representing a twist force applied to the second inceptor into a yaw rate command; and
converting signals from a switch on the second inceptor into a conversion command.

8. The flight control system of claim 2, wherein the instructions further causing the flight control computer to:
transition from longitudinal velocity and lateral velocity changes in hover flight mode to longitudinal acceleration changes and roll rate changes in cruise flight mode at a discrete airspeed.

9. The flight control system of claim 2, wherein the instructions further causing the flight control computer to:
transition from altitude rate changes and yaw rate changes in hover flight mode to flight path angle changes and sideslip changes in cruise flight mode at a first airspeed when the tiltrotor aircraft is accelerating, and
transition from flight path angle changes and sideslip changes in cruise flight mode to altitude rate changes and yaw rate changes in hover flight mode at a second airspeed when the tiltrotor aircraft is decelerating, wherein the second airspeed is lower than the first airspeed.

10. The flight control system of claim 1, wherein the plurality of propulsion systems have a generally vertical orientation in the hover mode and a generally horizontal orientation in the cruise mode, and wherein additional propulsion systems are fixed in a horizontal position.

11. A method for controlling a tiltrotor aircraft, comprising:
receiving, by a flight control computer, control inputs from a first inceptor and a second inceptor;
using the first inceptor inputs to command longitudinal speed and acceleration of the tiltrotor aircraft in both a hover flight mode and a cruise flight mode; and
using the second inceptor inputs to command climb and descent rates in both hover and cruise flight modes.

12. The method of claim 11, further comprising:
converting a signal representing a longitudinal force applied to the first inceptor into an altitude rate change in hover flight mode or into a flight path angle change in cruise flight mode;
converting a signal representing a longitudinal force applied to the second inceptor into a longitudinal velocity in hover flight mode or into a longitudinal acceleration in cruise flight mode;
converting a signal representing a lateral force applied to the second inceptor into a lateral velocity in hover flight mode or into a roll rate in cruise flight mode; and
converting a signal representing a twist force applied to the second inceptor into a yaw rate command in hover flight mode or into a sideslip command in cruise flight mode.

13. The method of claim 11, further comprising:
converting a signal representing a longitudinal force applied to the first inceptor into a thrust offset command, wherein forward-directed forces correspond to a thrust decrease and backward-directed forces correspond to a thrust increase;
converting signals from a switch on the first inceptor into a thrust bias setting;
converting a signal representing a longitudinal force applied to the second inceptor into a pitch attitude command;
converting a signal representing a lateral force applied to the second inceptor into a roll attitude command;
converting a signal representing a twist force applied to the second inceptor into a yaw rate command; and
converting signals from a switch on the second inceptor into a conversion command.

14. The method of claim 11, further comprising:
converting a signal representing a longitudinal force applied to the first inceptor into an altitude rate change in hover flight mode or into a flight path angle change in cruise flight mode;
converting a signal representing a longitudinal force applied to the second inceptor into a longitudinal velocity in hover flight mode or into a longitudinal acceleration in cruise flight mode;
converting a signal representing a lateral force applied to the second inceptor into a lateral velocity in hover flight mode or into a roll rate in cruise flight mode; and
converting signals representing forces applied to floor pedals into a yaw rate command in hover flight mode or into a sideslip command in cruise flight mode.

15. The method of claim 11, further comprising:
converting a signal representing a longitudinal force applied to the first inceptor into a longitudinal velocity in hover flight mode or into a longitudinal acceleration in cruise flight mode;
converting a signal representing a longitudinal force applied to the second inceptor into;
an altitude rate change in hover flight mode or into a flight path angle change in cruise flight mode;
converting a signal representing a lateral force applied to the second inceptor into a lateral velocity in hover flight mode or into a roll rate in cruise flight mode; and
converting a signal representing a twist force applied to the second inceptor into a yaw rate command in hover flight mode or into a sideslip command in cruise flight mode.

16. The method of claim 11, further comprising:
converting a signal representing a longitudinal force applied to the first inceptor into a longitudinal velocity in hover flight mode or into a longitudinal acceleration in cruise flight mode;
converting a signal representing a longitudinal force applied to the second inceptor into;
an altitude rate change in hover flight mode or into a flight path angle change in cruise flight mode;
converting a signal representing a lateral force applied to the second inceptor into a lateral velocity in hover flight mode or into a roll rate in cruise flight mode; and
converting signals representing forces applied to floor pedals into a yaw rate command in hover flight mode or into a sideslip command in cruise flight mode.

17. The method of claim 11, further comprising:
converting a signal representing a longitudinal force applied to the first inceptor into a thrust offset command, wherein forward-directed forces correspond to a thrust increase and backward-directed forces correspond to a thrust decrease;
converting signals from a switch on the first inceptor into a thrust bias setting;
converting a signal representing a longitudinal force applied to the second inceptor into a pitch attitude command;
converting a signal representing a lateral force applied to the second inceptor into a roll attitude command;
converting a signal representing a twist force applied to the second inceptor into a yaw rate command; and
converting signals from a switch on the second inceptor into a conversion command.

18. The method of claim 11, further comprising:
transiting from longitudinal velocity and lateral velocity changes in hover flight mode to longitudinal acceleration changes and roll rate changes in cruise flight mode over a defined ground speed range.

19. The method of claim 11, further comprising:
transitioning from altitude rate changes and yaw rate changes in hover flight mode to flight path angle changes and sideslip changes in cruise flight mode at a first airspeed when the tiltrotor aircraft is accelerating; and
transitioning from flight path angle changes and sideslip changes in cruise flight mode to altitude rate changes and yaw rate changes in hover flight mode at a second airspeed when the tiltrotor aircraft is decelerating, wherein the second airspeed is lower than the first airspeed.

20. An tiltrotor aircraft, comprising:
a fuselage;
a cockpit within the fuselage, the cockpit including a first inceptor and a second inceptor;
a wing connected to the fuselage;
a first set of propulsion systems configured to tilt between a first position when the tiltrotor aircraft is in a hover mode and a second position when the tiltrotor aircraft is in a cruise mode;
a second set of propulsion systems configured to remain in a fixed orientation;
a flight control system configured to control the first and second sets of propulsion systems in response to inputs from the first and second inceptors, the flight control computer adapted to:
convert a signal representing a longitudinal force applied to the first inceptor into an altitude rate change in hover flight mode or into a flight path angle change in cruise flight mode;
convert a signal representing a longitudinal force applied to the second inceptor into a longitudinal velocity in hover flight mode or into a longitudinal acceleration in cruise flight mode;
convert a signal representing a lateral force applied to the second inceptor into a lateral velocity in hover flight mode or into a roll rate in cruise flight mode; and
convert a signal representing a twist force applied to the second inceptor into a yaw rate command in hover flight mode or into a sideslip command in cruise flight mode.
